(19) United States
(12) Patent Application Publication
(10) Pub. No.: US 2015/0348182 A1
(43) Pub. Date: Dec. 3, 2015

(54) PREPROVISION ONBOARDING PROCESS

(71) Applicant: Bank of America Corporation, Charlotte, NC (US)

(72) Inventors: Sorin N. Cismas, Addison, TX (US); Manu Jacob Kurian, St. Louis, MO (US)

(73) Assignee: Bank of America Corporation, Charlotte, NC (US)

(21) Appl. No.: 14/289,110

(22) Filed: May 28, 2014

(51) Int. Cl. G06Q 40/02

(52) U.S. Cl. CPC G06Q 40/02

(57) ABSTRACT

Disclosed is a system for onboarding a new customer. The system for onboarding a new customer typically includes a processor, a memory, and a customer onboarding module stored in the memory. The system for onboarding a new customer is typically configured for: creating a first pre-provisioned account, the first pre-provisioned account including generic customer information and account access credentials; storing the first pre-provisioned account in an account database; initiating an onboarding session with a customer; selecting the first pre-provisioned account from the account database; receiving customer-specific information from the customer and replacing generic customer information in the first pre-provisioned account with the customer-specific information; providing the first pre-provisioned account's access credentials to the customer; testing the customer's access to the first pre-provisioned account; determining that the customer successfully accessed the first pre-provisioned account; and based on determining that the customer successfully accessed the first pre-provisioned account, terminating the onboarding session.

### FIELD OF THE INVENTION

The present invention embraces a system for onboarding a new customer. The system typically includes a processor and a memory. The system also typically includes a customer onboarding module stored in the memory, which is typically configured for: creating a first pre-provisioned account; initiating an onboarding session with a customer; selecting the first pre-provisioned account from the account database; receiving customer-specific information from the customer and replacing generic customer information in the first pre-provisioned account with the customer-specific information; testing the customer's access to the first pre-provisioned account; and based on determining that the customer successfully accessed the first pre-provisioned account, terminating the onboarding session.

### BACKGROUND

Over the last few years, there has been a proliferation of number and types of bank accounts available to consumers. That said, a need exists improved ways of providing bank accounts to consumers.

### SUMMARY

In one aspect, the present invention embraces a system for onboarding a new customer and an associated method and computer program product. The system for onboarding a new customer typically includes a processor and a memory. The system for onboarding a new customer also typically includes a customer onboarding module stored in the memory and executable by the processor. In one embodiment, the customer onboarding module is configured for: creating a first pre-provisioned account, the first pre-provisioned account including generic customer information and account access credentials; storing the first pre-provisioned account in an account database; initiating an onboarding session with a customer; during the onboarding session, selecting the first pre-provisioned account from the account database; during the onboarding session, receiving customer-specific information from the customer and replacing generic customer information in the first pre-provisioned account with the customer-specific information; during the onboarding session, providing the first pre-provisioned account's access credentials to the customer; during the onboarding session, testing the customer's access to the first pre-provisioned account; during the onboarding session, determining that the customer successfully accessed the first pre-provisioned account; and based on determining that the customer successfully accessed the first pre-provisioned account, terminating the onboarding session.

In one embodiment, creating the first pre-provisioned account comprises initiating account reconciliation backend processes and data transformation services backend processes for the first pre-provisioned account.

In a further embodiment, the customer onboarding module is configure for determining that the account reconciliation backend processes and data transformation services backend processes have been completed.

In another further embodiment, the customer onboarding module is configure for, based on determining that the account reconciliation backend processes and data transformation services backend processes have been completed, notifying a financial institution representative (e.g., a financial institution automated agent) that the first pre-provisioned account is ready for onboarding.

In yet another further embodiment, the data transformation services backend processes create the account access credentials for the first pre-provisioned account.

In another embodiment, determining that the customer successfully accessed the first pre-provisioned account comprises receiving a test file from the customer and determining that the test file has a valid data format.

In yet another embodiment, initiating an onboarding session with the customer comprises initiating an onboarding session between the customer and a financial institution representative (e.g., a financial institution automated agent).

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a method of pre-provisioning customer accounts in accordance with an exemplary embodiment of the present invention;

FIG. 2 depicts a method of onboarding a customer to a pre-provisioned customer account in accordance with an exemplary embodiment of the present invention;

FIG. 3 depicts a system for onboarding customers and operating environment in accordance with an exemplary embodiment of the present invention;

FIG. 4 schematically depicts a customer's computing device in accordance with an aspect of the present invention;

FIG. 5 schematically depicts a customer onboarding system in accordance with an exemplary embodiment of the present invention; and

FIG. 6 schematically depicts a banking system in accordance with an aspect of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a payment account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution. In this regard, other businesses can take the place of or work in conjunction with the financial institution to perform one or more of the processes or steps described herein as being performed by a financial institution. Still in other embodiments of the invention the financial institution described herein may be replaced with other types of businesses that offer payment account systems to customers.

As used herein, an “online banking account” is an account that is associated with one or more user accounts at a financial institution. For example, the user may have an online banking account that is associated with the user's checking account, savings account, prepaid account, investment account, and credit account at a particular financial institution (e.g., the financial institution providing the online banking account). In some embodiments, the user's online banking account at a particular financial institution may also provide the user with access and information regarding user accounts that are maintained other financial institutions. For example, the user may provide a first financial institution with login information associated with the user's online banking account at a second financial institution. A username and password are typically associated with the online banking account and can be used by the user to gain access to the online banking account. The online banking account may be accessed by the user over a network (e.g., the Internet) via a computer device, such as a personal computer, laptop, or mobile device (e.g., a smartphone or tablet). The online banking account may be accessed by the user via a mobile or online banking website or via a mobile or online banking application. A customer may access an online banking account to view account balances, view transaction history, view statements, transfer funds, and pay bills. More than one user may have access to the same online banking account. In this regard, each user may have a different username and password. Accordingly, one or more users may have a sub-account associated with the online banking account.

In some embodiments, the “user” may be a customer (e.g., an account holder or a person or organization who has an account (e.g., banking account, credit account, or the like) at the entity) or potential customer (e.g., a person or organization who has submitted an application for an account, a person who is the target of marketing materials that are distributed by the entity, a person who applies for a loan that not yet been funded). In other embodiments, the “customer” may refer to the user. In some embodiments, the customer may be a business or other organization that has an account at the entity.

The embodiments described herein may refer to the use of a transaction, transaction event or point of transaction event to trigger the steps, functions, routines, or the like described herein. In various embodiments, occurrence of a transaction triggers the sending of information such as offers and the like. Unless specifically limited by the context, a “transaction”, “transaction event” or “point of transaction event” refers to any communication between the customer and the merchant, financial institution, or other entity monitoring the customer's activities. In some embodiments, for example, a transaction may refer to a purchase of goods or services, a return of goods or services, a payment transaction, a credit transaction, or other interaction involving a customer's bank account. As used herein, a “bank account” refers to a credit account, a debit/deposit account, a payment account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a customer's computer or mobile device, a customer accessing their e-wallet or any other interaction involving the customer and/or the customer's device that is detectable by the financial institution. As further examples, a transaction may occur when an entity associated with the customer is alerted via the transaction of the customer's location. A transaction may occur when a customer accesses a building, uses a rewards card, and/or performs an account balance query. A transaction may occur as a customer's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

Whenever a customer (e.g., a new customer) of a financial institution wishes to add a new account (e.g., a payment account), the new account must be generated, information must be collected from the customer, and the new account must be configured and interconnected with various systems and processes of the financial institution. These steps must be completed before the customer can have complete access to the account and to any associated services provided by the financial institution. These steps, however, can be time consuming. Therefore, several days or weeks typically elapse between first receiving a request from the customer to add the new account and completing all of the account creation steps. This delay between requesting a new account and gaining full access to the account often leaves customers unsatisfied.

Accordingly, in one aspect the present invention embraces an improved process of onboarding customers to new accounts. In order to decrease the delay between a customer's request for a new account and the customer gaining full access to the account, a plurality of accounts are pre-provisioned before the customer requests a new account. During this pre-provisioning, the accounts are substantially configured and interconnected with various systems and processes of the financial institution. Thereafter, when the customer requests a new account, a pre-previsioned account may be selected, and its configuration may be completed in a fairly short time period (e.g., several minutes or hours). Accordingly, the delay between the customer requesting a new account and gaining full access to the account may be greatly reduced.

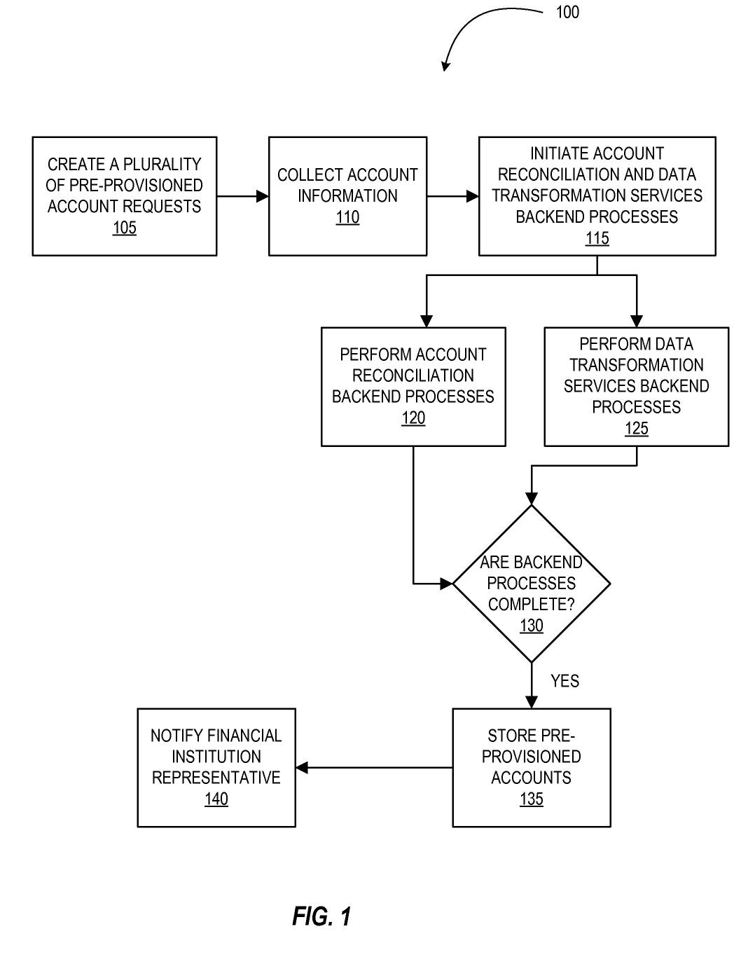

In this regard, FIG. 1 depicts a method 100 of pre-provisioning customer accounts in accordance with an exemplary embodiment of the present invention.

At block 105, a plurality of pre-provision account requests are created. In this regard, a representative (e.g., an account onboarding coordinator) of a financial institution typically submits a request to create a plurality of pre-provisioned accounts to a customer onboarding system. Alternatively, an automated process (e.g., an automated account onboarding process or automated agent) of the financial institution may submit a request to create a plurality of pre-provisioned accounts to a customer onboarding system. In a typical embodiment, each pre-provisioned account is a commercial account (e.g., a commercial payment account) that a business customer might wish to open. In some embodiments, each pre-provisioned account includes multiple interrelated accounts. For example, each pre-provisioned account may include a commercial payment account and an associated commercial online banking account.

At block 110, account information is collected. In this regard, the customer onboarding system may prompt the financial institution representative (or financial institution automated process or automated agent) to provide information needed to create the pre-provisioned account. This information typically includes, among other things, the type of account, geographic region, and customer-specific information (e.g., customer name, address, and the like). Where customer-specific information is requested or needed, generic (e.g., non-specific) information is typically inserted into any corresponding data field.

Next, at block 115, account reconciliation and data transformation services backend processes are initiated. In this regard, the customer onboarding system may prompt other financial institution systems to perform the account reconciliation backend processes and/or the data transformation services backend processes.

At block 120, account reconciliation backend processes are performed. During the account reconciliation backend processes, an account number is assigned to each pre-provisioned account. In addition, each pre-provisioned is interconnected with other financial institution systems and processes (e.g., in order to reconcile the pre-provisioned account with other accounts maintained by the financial institution). Each pre-provisioned account is typically tested to ensure proper functionality.

At block 125, data transformation services backend processes are performed. In this regard, the pre-provisioned accounts are typically configured to subsequently allow a customer to send data files that include transactions to be performed concerning the account. This data file would be then be processed by the financial institution and the transactions described therein performed. Accordingly, during the data transformation services backend processes, a delivery channel and end points are typically specified for each pre-provisioned account in order to allow data delivery and processing. Typically, the destination for such data is initially set to a test destination to facilitate testing during customer onboarding. In addition, during the data transformation services backend processes, account credentials (e.g., username and password) are typically created (e.g., auto-generated) for each pre-provisioned account. These account credentials typically allow customer access to an associated online banking account (e.g., where data files for processing can be delivered).

At block 130, it is determined whether or not the backend processes (e.g., the account reconciliation and data transformation services backend processes) have been completed.

If the backend processes have been completed, then, at block 135, the pre-provisioned accounts are stored in an account database. In addition, any further governance and compliance reporting is completed and the pre-provisioned accounts are made ready for use by the financial institution representative (or financial institution automated process).

Accordingly, at block 140, the financial institution representative (or financial institution automated process) is typically notified that the pre-provisioned accounts are ready for use (e.g., for onboarding a customer).

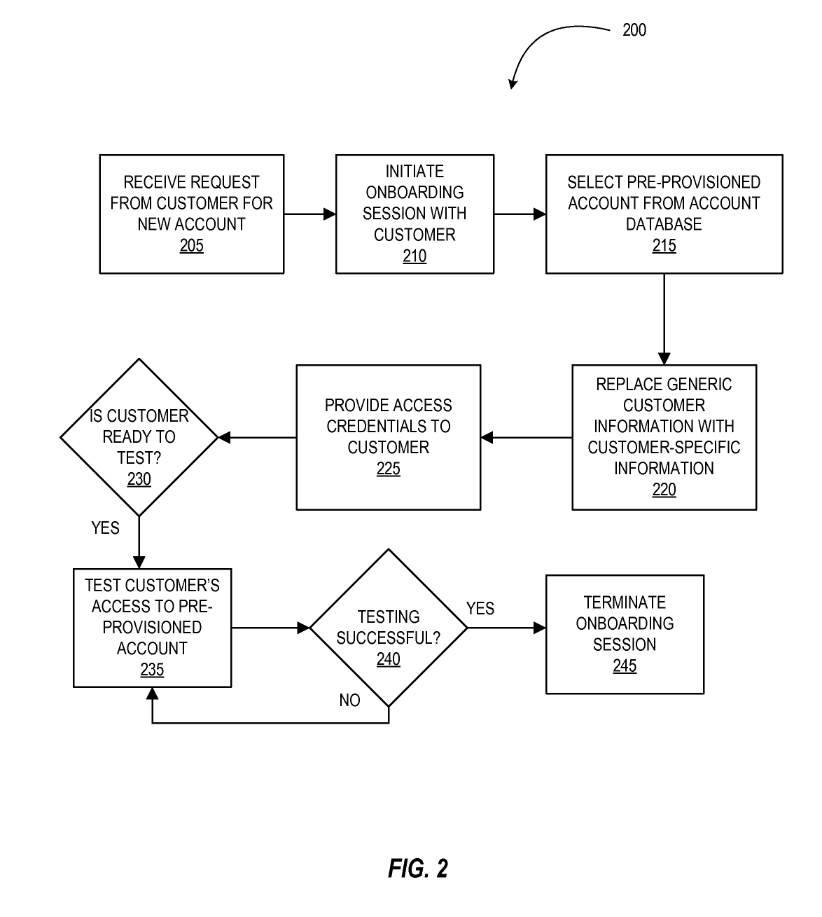

FIG. 2 depicts a method 200 of onboarding a customer to a pre-provisioned customer account in accordance with an exemplary embodiment of the present invention.

At block 205, the financial institution receives a request from a customer (e.g., a prospective customer) for a new account. In this regard, the customer may submit a request for the new account via a website of the financial institution or the customer may contact a sales associate of the financial institution.

If the type of account requested by the customer has been pre-provisioned (e.g., as described with respect to FIG. 1), then, at block 210, an onboarding session with the customer is initiated with the customer. The onboarding session is typically an interactive session (e.g., an in-person meeting, teleconference, or video conference) between the customer and a representative (or automated process) of the financial institution.

At block 215, a pre-provisioned account is selected (e.g., by the customer representative or automated process) from the account database.

Next, at block 220, generic customer information in the pre-provisioned account is replaced with customer-specific information (e.g., customer-specific information received during the onboarding session). In this regard, the customer is typically prompted to provide certain customer-specific information, such as customer name and address.

In order to facilitate account testing, at block 225, access credentials (e.g., username and password) associated with the pre-provisioned account may be provided to the customer.

At block 230, the customer is typically asked (e.g., by the financial institution representative or automated process) if it is ready to test the pre-provisioned account.

If the customer is ready to test the pre-provisioned account, then, at block 235, the customer's access to the pre-provisioned account is tested. In this regard, it is determined whether the customer can successfully login and access the account by using the provided account access credentials. If the customer can successfully login to the account, then the customer is typically prompted to transmit (e.g., using hypertext transfer protocol secure (HTTPS) or file transfer protocol secure (FTPS)) a test transaction data file. Thereafter it is determined whether the test transaction data file has been received and if the test data file has a valid data format. If, at block 240, it is determined that the testing has not been successfully completed, then such testing is repeated.

If the testing is successful, then, at block 245, the customer onboarding session is terminated and the pre-provisioned account is made ready for use by the customer (e.g., for the customer to send production transaction files). In this regard, if the destination for the data files was previously set to a testing destination, the destination for the data files is changed to a production destination.

The method 200 of onboarding a customer to a new account as described herein is highly advantageous over prior processes for onboarding a customer to a new account. In particular, rather than days elapsing between a customer request for a new account and the completion of the onboarding process, onboarding a customer to a pre-provisioned account (e.g., completing an onboarding session) as described herein can be completed in a matter of minutes.

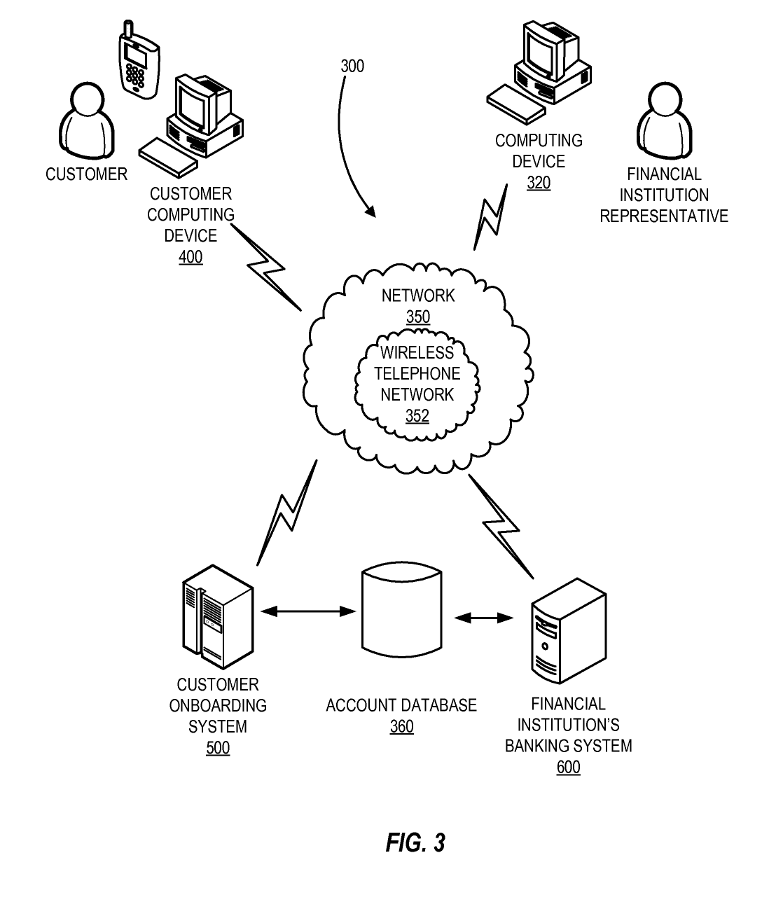

FIG. 3 depicts an operating environment 300 according to one embodiment of the present invention that implements a customer onboarding process using account pre-provisioning. As illustrated in FIG. 3, the operating environment 300 typically includes a computing device 320 used by a representative (or automated process) of the financial institution (e.g., for pre-provisioning accounts and onboarding customers as described herein), an account database 360, a customer computing device 400 (e.g., for requesting a new account and participating in an onboarding session), a customer onboarding system 500, and the financial institution's banking system 600.

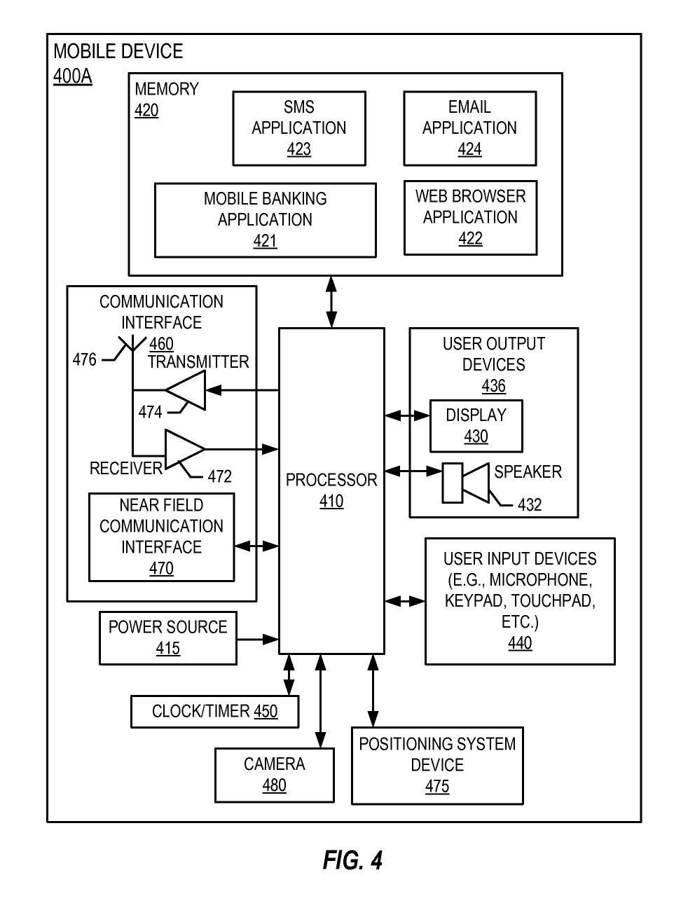

The computing device 320, customer computing device 400, customer onboarding system 500, and the financial institution's banking system 600 are typically configured to communicate over a network 350. The customer computing device 400, customer onboarding system 500, and the financial institution's banking system 600 are each described in greater detail below with reference to FIGS. 4-6. The network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet. In one embodiment, the network 350 includes a wireless telephone network 352.

The computing device 400 may be any device that employs a processor and memory and can perform computing functions, such as a personal computer or a mobile device. In this regard, FIG. 4 provides a block diagram illustrating the customer's computing device as a mobile device 400A, in accordance with embodiments of the invention. In one embodiment of the invention, the mobile device 400A is a mobile telephone. However, it should be understood, however, that a mobile telephone is merely illustrative of one type of mobile device that may benefit from, employ, or otherwise be involved with embodiments of the present invention and, therefore, should not be taken to limit the scope of embodiments of the present invention. Other types of mobile devices may include portable digital assistants (PDAs), pagers, mobile televisions, gaming devices, laptop computers, tablet computers, cameras, video recorders, audio/video player, radio, GPS devices, or any combination of the aforementioned.

The mobile device 400A typically includes a processor 410 communicably coupled to such devices as a memory 420, user output devices 436, user input devices 440, a communication interface 460, a power source 415, a clock or other timer 450, a camera 480, and a positioning system device 475. The processor 410, and other processors described herein, typically includes circuitry for implementing communication and/or logic functions of the mobile device 400A. For example, the processor 410 may include a digital signal processor device, a microprocessor device, and various analog to digital converters, digital to analog converters, and/or other support circuits. Control and signal processing functions of the mobile device 400A are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400A to transmit and receive web content, such as, for example, location-based content and/or other web page content, according to a Wireless Application Protocol (WAP), Hypertext Transfer Protocol (HTTP), and/or the like.

The processor 410 is typically configured to use the communication interface 460 to communicate with one or more other devices on the network 350. In this regard, the communication interface 460 typically includes an antenna 476 operatively coupled to a transmitter 474 and a receiver 472 (together a “transceiver”). The processor 410 is typically configured to provide signals to and receive signals from the transmitter 474 and receiver 472, respectively. The signals may include signaling information in accordance with the air interface standard of the applicable cellular system of the wireless telephone network 352. In this regard, the mobile device 400A may be configured to operate with one or more air interface standards, communication protocols, modulation types, and access types. By way of illustration, the mobile device 400A may be configured to operate in accordance with any of a number of first, second, third, and/or fourth-generation communication protocols and/or the like. For example, the mobile device 400A may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400A may also be configured to operate in accordance with non-cellular communication mechanisms, such as via a wireless local area network (WLAN) or other communication/data networks.

The communication interface 460 may also include a near field communication (NFC) interface 470. As used herein, the phrase “NFC interface” generally refers to hardware and/or software that is configured to contactlessly and/or wirelessly send and/or receive information over relatively short ranges (e.g., within four inches, within three feet, within fifteen feet, and the like). The NFC interface 470 may include a smart card, key card, proximity card, Bluetooth® device, radio frequency identification (RFID) tag and/or reader, transmitter, receiver, and/or the like. In some embodiments, the NFC interface 470 communicates information via radio, infrared (IR), and/or optical transmissions. In some embodiments, the NFC interface 470 is configured to operate as an NFC transmitter and/or as an NFC receiver (e.g., an NFC reader). Also, it will be understood that the NFC interface 470 may be embedded, built, carried, and/or otherwise supported in and/or on the mobile device 400A. In some embodiments, the NFC interface 470 is not supported in and/or on the mobile device 400A, but the NFC interface 470 is otherwise operatively connected to the mobile device 400A (e.g., where the NFC interface 470 is a peripheral device plugged into the mobile device 400A). Other apparatuses having NFC interfaces mentioned herein may be configured similarly. In some embodiments, the NFC interface 470 of the mobile device 400A is configured to contactlessly and/or wirelessly communicate information to and/or from a corresponding NFC interface of another apparatus (e.g., an automated teller machine (ATM) or another mobile or computing device).

The mobile device 400A typically has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile device 400A to receive data from a user such as the user, may include any of a number of devices allowing the mobile device 400A to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile device 400A may also include a positioning system device 475 that is configured to be used by a positioning system to determine a location of the mobile device 400A. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 400A. In other embodiments, the positioning system device 475 includes a proximity sensor or transmitter, such as an RFID tag, that can sense or be sensed by devices known to be located proximate a location to determine that the mobile device 400A is located proximate these known devices.

The mobile device 400A further includes a power source 415, such as a battery, for powering various circuits and other devices that are used to operate the mobile device 400A. Embodiments of the mobile device 400A may also include a clock or other timer 450 configured to determine and, in some cases, communicate actual or relative time to the processor 410 or one or more other devices.

The mobile device 400A also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which include computer-executable instructions/code executed by the processor 410 to implement the functions of the mobile device 400A described herein. For example, the memory 420 may include such applications as a conventional web browser application 422 and/or a mobile banking application 421. These applications also typically provide a graphical user interface (GUI) on the display 430 that allows the user to communicate with the mobile device 400A, the banking system 600, and/or other devices or systems. In one embodiment of the invention, when the user decides to enroll in an online banking program, the user downloads or otherwise obtains the mobile banking system client application from the banking system 600 or from a distinct application server. In other embodiments of the invention, the user interacts with the banking system 600 via the web browser application 422 in addition to, or instead of, the mobile banking application 421. The banking system 600 is typically configured to present a graphical user interface (e.g., through a mobile banking application or mobile banking website) that allows the user to use the mobile device 400A to control access to the user's online banking account.

The memory 420 can also store any of a number of pieces of information, and data, used by the mobile device 400A and the applications and devices that make up the mobile device 400A or are in communication with the mobile device 400A to implement the functions of the mobile device 400A and/or the other systems described herein. For example, the memory 420 may include such data as user authentication information.

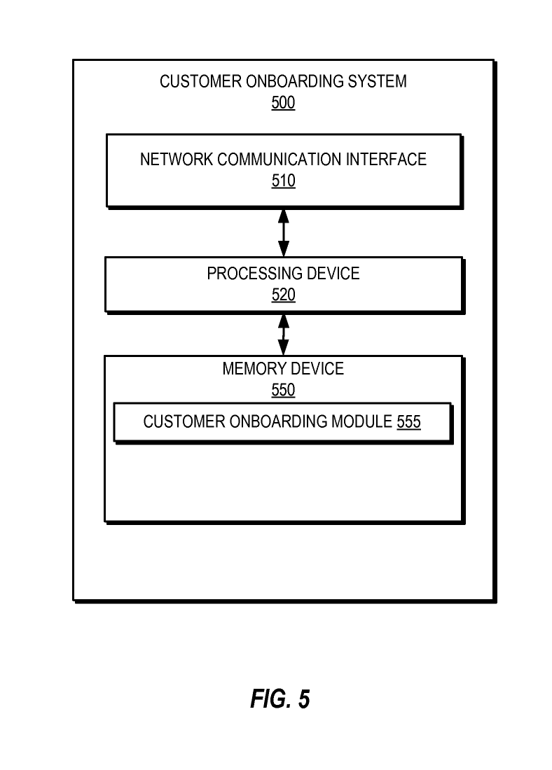

FIG. 5 depicts the customer onboarding system 500 in more detail. As depicted in FIG. 2 customer onboarding system 500 typically includes various features such as a network communication interface 510, a processing device 520, and a memory device 550. The network communication interface 510 includes a device that allows the customer onboarding system 500 to communicate over the network 350 (shown in FIG. 3) with the customer (e.g., via the customer computing device 400), financial institution customer representative or automated process (e.g., via the computing device 320), or banking system 600. The network communication interface 510 may also allow the customer onboarding system 500 to communicate with the account database 360 (e.g., to store or retrieve pre-provisioned accounts).

As used herein, a “processing device” or “processor,” such as the processing device 520, generally refers to a device or combination of devices having circuitry used for implementing the communication and/or logic functions of a particular system. For example, a processing device 520 may include a digital signal processor device, a microprocessor device, and various analog-to-digital converters, digital-to-analog converters, and other support circuits and/or combinations of the foregoing. Control and signal processing functions of the system are allocated between these processing devices (e.g., processors) according to their respective capabilities. The processing device 520 may further include functionality to operate one or more software programs based on computer-executable program code thereof, which may be stored in a memory. As the phrase is used herein, a processing device 520 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device,” such as the memory device 550, generally refers to a device or combination of devices that store one or more forms of computer-readable media for storing data and/or computer-executable program code/instructions. Computer-readable media is defined in greater detail below. For example, in one embodiment, the memory device 550 includes any computer memory that provides an actual or virtual space to temporarily or permanently store data and/or commands provided to the processing device 520 when it carries out its functions described herein.

The customer onboarding system 500 is typically configured to create pre-provisioned account and onboard customers to such pre-provisioned accounts as described herein. Accordingly, the customer onboarding system 500 typically includes one or more modules stored in the memory device 550, which facilitate account pre-provisioning and onboarding customers. As depicted in FIG. 5, the system 500 typically includes a customer onboarding module 555.

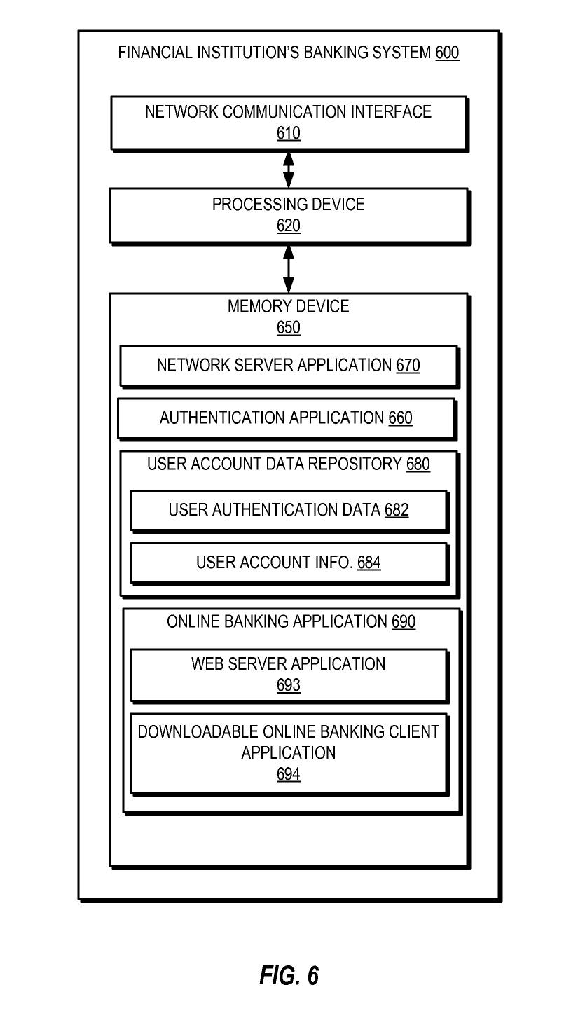

FIG. 6 provides a block diagram illustrating the banking system 600 in greater detail, in accordance with an embodiment of the invention. As illustrated in FIG. 6, in one embodiment of the invention, the banking system 600 includes a processing device 620 operatively coupled to a network communication interface 610 and a memory device 650. In certain embodiments, the banking system 600 is operated by the financial institution, while in other embodiments, the banking system 600 is operated by an entity other than a financial institution.

It should be understood that the memory device 650 may include one or more databases or other data structures/repositories. The memory device 650 also includes computer-executable program code that instructs the processing device 620 to operate the network communication interface 610 to perform certain communication functions of the banking system 600 described herein. For example, in one embodiment of the banking system 600, the memory device 650 includes, but is not limited to, a network server application 670, an authentication application 660, a user account data repository 680 which includes user authentication data 680 and user account information 684, an online banking application 690 which includes a web server application 693, a downloadable online banking client application 694, and other computer-executable instructions or other data. The computer-executable program code of the network server application 670, the authentication application 660, or the online banking application 690 may instruct the processing device 620 to perform certain logic, data-processing, and data-storing functions of the banking system 600 described herein, as well as communication functions of the banking system 600. In this regard, the processing device 620 is typically configured to allow customers to access their account(s).

In one embodiment, the user account data repository 680 includes user authentication data 682 and user account information 684. The network server application 670, the authentication application 660, and the online banking application 690 are configured to implement user account information 684 and the user authentication data 682 (e.g., user identification information) when authenticating a user to the banking system 600. In this regard, the user authentication data 682 may include a user's username, password, and/or PIN number. The user account information 684 may include account identification information.

As used herein, a “communication interface” typically includes a modem, server, transceiver, and/or other device for communicating with other devices on a network, and/or a user interface for communicating with one or more users. Referring again to FIG. 6, the network communication interface 610 is a communication interface having one or more communication devices configured to communicate with one or more other devices on the network 350, such as the customer computing device 400, and the customer onboarding system 500. The processing device 620 is typically configured to use the network communication interface 610 to transmit and/or receive data and/or commands to and/or from the other devices connected to the network 350.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for onboarding a customer, comprising:
a processor;
a memory;
a customer onboarding module stored in the memory, executable by the processor and configured for:
creating a first pre-provisioned account, the first pre-provisioned account including generic customer information and account access credentials;
storing the first pre-provisioned account in an account database;
initiating an onboarding session with a customer;
during the onboarding session, selecting the first pre-provisioned account from the account database;
during the onboarding session, receiving customer-specific information from the customer and replacing generic customer information in the first pre-provisioned account with the customer-specific information;
during the onboarding session, providing the first pre-provisioned account's access credentials to the customer;
during the onboarding session, testing the customer's access to the first pre-provisioned account;
during the onboarding session, determining that the customer successfully accessed the first pre-provisioned account; and
based on determining that the customer successfully accessed the first pre-provisioned account, terminating the onboarding session.

2. The system according to claim 1, wherein creating the first pre-provisioned account comprises initiating account reconciliation backend processes and data transformation services backend processes for the first pre-provisioned account.

3. The system according to claim 2, wherein the customer onboarding module is configure for determining that the account reconciliation backend processes and data transformation services backend processes have been completed.

4. The system according to claim 2, wherein the customer onboarding module is configure for, based on determining that the account reconciliation backend processes and data transformation services backend processes have been completed, notifying a financial institution representative that the first pre-provisioned account is ready for onboarding.

5. The system according to claim 2, wherein the data transformation services backend processes create the account access credentials for the first pre-provisioned account.

6. The system according to claim 1, wherein determining that the customer successfully accessed the first pre-provisioned account comprises receiving a test file from the customer and determining that the test file has a valid data format.

7. The system according to claim 1, wherein initiating an onboarding session with the customer comprises initiating an onboarding session between the customer and a financial institution representative.

8. A computer program product for onboarding a customer comprising a non-transitory computer-readable storage medium having computer-executable instructions for:
creating a first pre-provisioned account, the first pre-provisioned account including generic customer information and account access credentials;
storing the first pre-provisioned account in an account database;
initiating an onboarding session with a customer;
selecting the first pre-provisioned account from the account database;
during the onboarding session, receiving customer-specific information from the customer and replacing generic customer information in the first pre-provisioned account with the customer-specific information;
during the onboarding session, providing the first pre-provisioned account's access credentials to the customer;
during the onboarding session, testing the customer's access to the first pre-provisioned account;
during the onboarding session, determining that the customer successfully accessed the first pre-provisioned account; and
based on determining that the customer successfully accessed the first pre-provisioned account, terminating the onboarding session.

9. The computer program product according to claim 8, wherein creating the first pre-provisioned account comprises initiating account reconciliation backend processes and data transformation services backend processes for the first pre-provisioned account.

10. The computer program product according to claim 9, wherein the non-transitory computer-readable storage medium has computer-executable instructions for determining that the account reconciliation backend processes and data transformation services backend processes have been completed.

11. The computer program product according to claim 9, wherein the non-transitory computer-readable storage medium has computer-executable instructions for, based on determining that the account reconciliation backend processes and data transformation services backend processes have been completed, notifying a financial institution representative that the first pre-provisioned account is ready for onboarding.

12. The computer program product according to claim 9, wherein the data transformation services backend processes create the account access credentials for the first pre-provisioned account.

13. The computer program product according to claim 8, wherein determining that the customer successfully accessed the first pre-provisioned account comprises receiving a test file from the customer and determining that the test file has a valid data format.

14. The computer program product according to claim 8, wherein initiating an onboarding session with the customer comprises initiating an onboarding session between the customer and a financial institution representative.

15. A method for onboarding a customer, comprising:
creating a first pre-provisioned account, the first pre-provisioned account including generic customer information and account access credentials;
storing the first pre-provisioned account in an account database;
initiating an onboarding session with a customer;
selecting the first pre-provisioned account from the account database;
during the onboarding session, receiving customer-specific information from the customer and replacing generic customer information in the first pre-provisioned account with the customer-specific information;
during the onboarding session, providing the first pre-provisioned account's access credentials to the customer;
during the onboarding session, testing the customer's access to the first pre-provisioned account;
during the onboarding session, determining, via a computer processor, that the customer successfully accessed the first pre-provisioned account; and
based on determining that the customer successfully accessed the first pre-provisioned account, terminating the onboarding session.

16. The method according to claim 15, wherein creating the first pre-provisioned account comprises initiating account reconciliation backend processes and data transformation services backend processes for the first pre-provisioned account.

17. The method according to claim 16, comprising determining that the account reconciliation backend processes and data transformation services backend processes have been completed.

18. The method according to claim 16, comprising, based on determining that the account reconciliation backend processes and data transformation services backend processes have been completed, notifying a financial institution representative that the first pre-provisioned account is ready for onboarding.

19. The method according to claim 16, wherein the data transformation services backend processes create the account access credentials for the first pre-provisioned account.

20. The method according to claim 15, wherein determining that the customer successfully accessed the first pre-provisioned account comprises receiving a test file from the customer and determining that the test file has a valid data format.

21. The method according to claim 15, wherein initiating an onboarding session with the customer comprises initiating an onboarding session between the customer and a financial institution representative.
